(19) United States
(12) Patent Application Publication
(10) Pub. No.: US 2017/0203679 A1
(43) Pub. Date: Jul. 20, 2017

(54) VEHICLE FLOOR MAT WITH FLEXIBLE PERIPHERAL PORTION

(71) Applicant: Koolatron Corporation, Brantford (CA)

(72) Inventor: Benoit Bouchard, Terrebonne (CA)

(21) Appl. No.: 14/996,710

(22) Filed: Jan. 15, 2016

(51) Int. Cl. B60N 3/04

(52) U.S. Cl. CPC B60N 3/048; B60N 3/044

(57) ABSTRACT

A vehicle floor mat includes a containment portion, a high border generally surrounding the containment portion along the top thereof, and a base rim generally surrounding the containment portion along the bottom thereof. At least one flexible peripheral portion adjoins the containment portion. The flexible peripheral portion may have a bottom surface that is offset from a lower surface of the base rim to define an offset dimension. The base rim may include an outer side wall that extends upwardly from the lower surface to the bottom surface of the flexible peripheral portion. The flexible peripheral portion may be arranged inclined upwardly at an acute angle relative to a plane defined by the lower surface of the base rim.

### FIELD

The present disclosure relates generally to vehicle floor mats.

### INTRODUCTION

The following is intended to introduce the reader to the detailed description that follows and not to define or limit the claimed subject matter.

In an aspect of the present disclosure, a vehicle floor mat may include: a containment portion having a top, a bottom, a length extending in a longitudinal direction and width extending in a lateral direction; a high border generally surrounding the containment portion along the top thereof, the high border having an upper surface that is offset from the containment portion in a vertical direction for segregating liquid in the containment portion; a base rim generally surrounding the containment portion along the bottom thereof, the base rim having a lower surface for engaging a vehicle floor; and at least one flexible peripheral portion adjoining the containment portion, the at least one flexible peripheral portion having a bottom surface that is offset from the lower surface of the base rim in the vertical direction.

In an aspect of the present disclosure, a vehicle floor mat may include: a containment portion having a top, a bottom, a length extending in a longitudinal direction and width extending in a lateral direction; a high border generally surrounding the containment portion along the top thereof, the high border having an upper surface that is offset from the containment portion in a vertical direction for segregating liquid in the containment portion; a base rim generally surrounding the containment portion along the bottom thereof, the base rim having a lower surface for engaging a vehicle floor, the high border and the base rim being arranged to generally coincide in the vertical direction, each of the high border and the base rim including first and second length sections that are spaced from one another in the lateral direction and extend generally in the longitudinal direction at least partially along the length of the containment portion, and a first width section that extends generally in the lateral direction along the width of the containment portion between the first and second length sections; first, second and third peripheral portions, the first flexible peripheral portion adjoining the first length sections of the high border and the base rim, the second flexible peripheral portion adjoining the second length sections of the high border and the base rim, and the third flexible peripheral portion adjoining the first width sections of the high border and the base rim and connected between the first and second flexible peripheral portions, each of the first, second and third peripheral portions including a bottom surface that is offset from the lower surface of the base rim in the vertical direction; and first and second corner portions that interconnect the first and second flexible peripheral portions with the third flexible peripheral portion, respectively.

In an aspect of the present disclosure, a vehicle floor mat may include: a containment portion; a base rim generally surrounding the containment portion along a bottom thereof, the base rim including a lower surface for engaging a vehicle floor, and an outer side wall that extends upwardly from the lower surface; and a flexible peripheral portion adjoining the containment portion, the flexible peripheral portion having a bottom surface that is connected to the outer side wall of the base rim, and the flexible peripheral portion is arranged inclined upwardly at an acute angle relative to a plane defined by the lower surface of the base rim.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way.

FIG. 1 is a top view of an example of a vehicle floor mat.

FIG. 2 is a bottom view of the vehicle floor mat of FIG. 1.

FIG. 3 is a side view of the vehicle floor mat of FIG. 1.

FIG. 4 is an end view of the vehicle floor mat of FIG. 1.

FIG. 5 is a detailed top view of a portion of the vehicle floor mat of FIG. 1.

FIG. 6 is a detailed bottom view of the portion of the vehicle floor mat of FIG. 1.

FIG. 7 is a sectional view taken along line 7-7 in FIGS. 5 and 6.

FIG. 8 is a sectional view taken along line 8-8 in FIGS. 5 and 6.

FIG. 9 is a perspective view of a corner portion of the vehicle floor mat of FIG. 1.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Generally speaking, so-called “universal” vehicle mats may offer good protection for a vehicle's floor. However, these mats may provide only a partial solution to the main problems of the mess caused by the winter season on a vehicle floor's carpet, because they typically only protect the base of the floor space. These mats typically do not give protection for the problem of the mess left on your car carpet after the winter season, with stains of road salt and other debris that may appear on each side of the floor space, namely the side of the foot well and the transmission bump. Also, there exists the potential for corrosion of electrical wiring systems located under the driver seat.

Most universal car mats on the retail market do not offer protection for the sides of the floor space and for underneath the seats. So-called “custom fit” mats are available and may provide greater protection, but typically these vehicle floor mats are significantly more expensive than a universal mat.

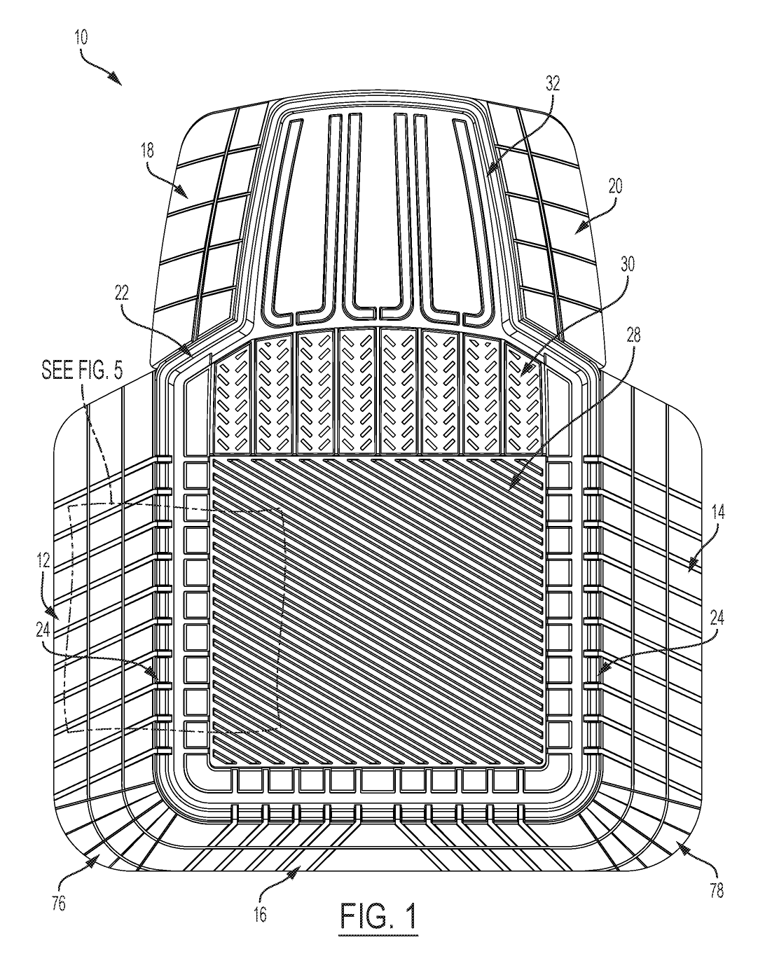

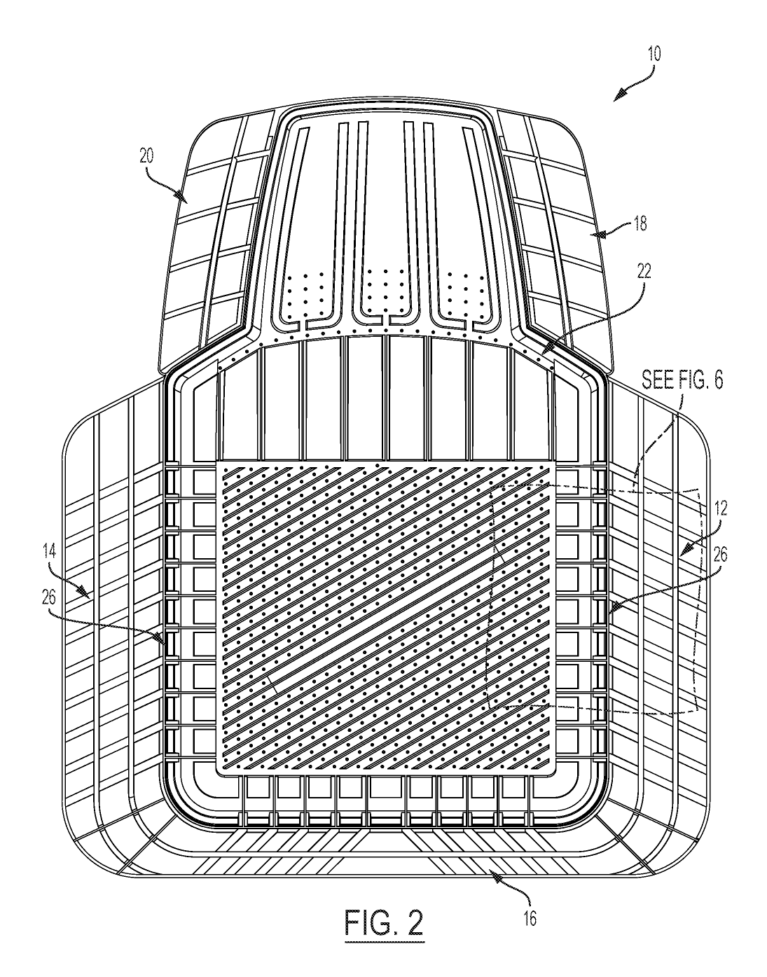

Referring to FIGS. 1 and 2, a vehicle floor mat is shown generally at reference numeral 10. The vehicle floor mat 10 includes flexible peripheral portions that provide improved protection in the areas to the side of the floor space, at the side of the foot well and the transmission bump, as well as underneath the seat. In the example illustrated, the vehicle floor mat 10 includes first, second, third, fourth and fifth flexible peripheral portions 12, 14, 16, 18, 20, which are described in greater detail below.

The vehicle floor mat 10 may be generally planar and unitary in design, and have a durable construction of molded rubber, plastic or other suitable material which is moldable, flexible, and durable. In some examples, the vehicle floor mat 10 may be manufactured by injection molding of PVC material.

In the example illustrated, the vehicle floor mat 10 includes a containment portion 22 having a top (shown in FIG. 1) and a bottom (shown in FIG. 2). A high border 24 is shown surrounding the containment portion 22 along the top thereof. A base rim 26 is shown surrounding the containment portion 22 along the bottom thereof.

As illustrated in FIG. 1, the containment portion 22 includes a central pan 28, a heel pad 30 adjoining the central pan 28, and a toe pad 32 adjoining the heel pad 30. The toe pad 32 may be positioned against an inclined surface of the foot well of the vehicle, near the vehicle pedals. The central pan 28 may be disposed in a generally horizontal position in front of the seat. The heel pad 30 may be positioned in a transition area between the inclined toe pad 32 and the generally level central pan 28, so that liquid and debris collected in the heel and toe pads 30, 32 may be collected into the central pan 28 by force of gravity. The heel and toe pads 30, 32 may each be formed of a relatively thick section of material and include various ridges or other traction features to provide a non-slip surface and allow for migration of liquid to the central pan 28.

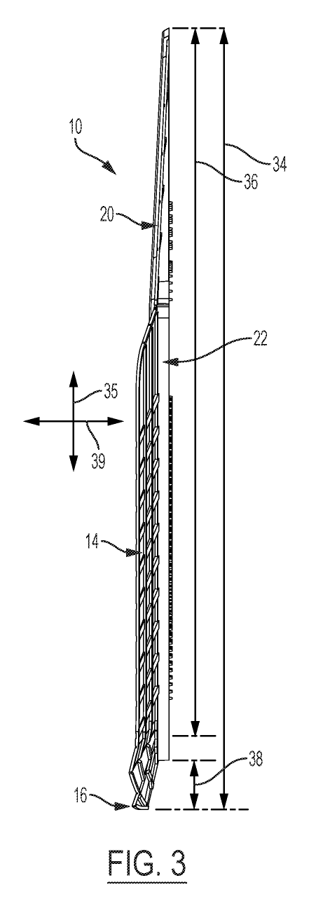

In the example illustrated, referring to FIG. 3, the vehicle floor mat 10 has an overall length 34 extending in a longitudinal direction 35. The containment portion has a length 36 and the third flexible peripheral portion 16 has a length dimension 38, each extending in the longitudinal direction 35. In some examples, as illustrated, the length dimension 38 may be at least 6% of the length 36.

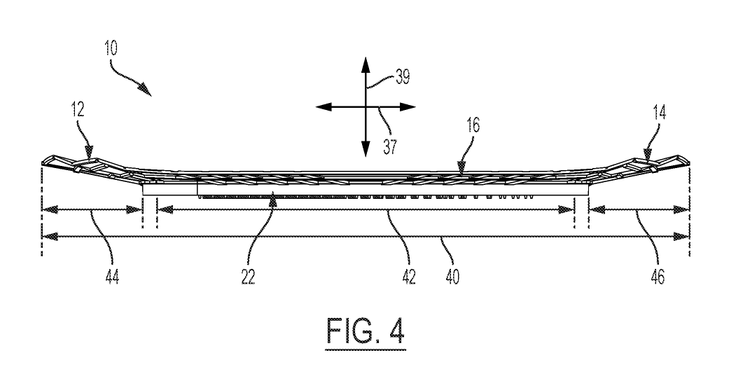

In the example illustrated, referring to FIG. 4, the vehicle floor mat 10 has an overall width 40 extending in a lateral direction 37. The containment portion has a width 42, the first flexible peripheral portion 12 has a width dimension 44, and the second flexible peripheral portion 14 has a width dimension 46, each extending in the lateral direction 37. In some examples, as illustrated, each of the width dimensions 44, 46 may be at least 20% of the width 42.

Sizing of the vehicle floor mat 10 may be selected so that it has a satisfactory fit with a wide range of vehicles, e.g., most cars, SUV's and pickup trucks. For the sake of illustration, and not intended to be limiting, the overall length 34 may be on the order of 25 inches, and the overall width 40 may be on the order of 30 inches.

Referring to FIGS. 3 and 4, the flexible peripheral portions 12, 14, 16 are each shown inclined upwardly in a vertical direction 39, which is described in greater detail below.

In the example illustrated, referring to FIGS. 1-4, the high border 24 and the base rim 26 are arranged to coincide in the vertical direction 39, with the containment portion 22 separated from the flexible peripheral portions 12, 14, 16, 18, 20 by each of the high border 24 and the base rim 26.

In particular, each of the high border 24 and the base rim 26 are shown to include first and second length sections that are spaced from one another in the lateral direction 37 and extend in the longitudinal direction 35, at least partially along the length 36 of the containment portion 22. The first flexible peripheral portion 12 is shown adjoining the first length sections of the high border 24 and the base rim 26, and the second flexible peripheral portion 14 is shown adjoining the second length sections of the high border 24 and the base rim 26. Each of the high border 24 and the base rim 26 are further shown to include a first width section that extends generally in the lateral direction 37 along the width 42 of the containment portion 22 between the first and second length sections. The third flexible peripheral portion 16 is shown adjoining the first width sections of the high border 24 and the base rim 26 and connected between the first and second flexible peripheral portions 12, 14. In the example illustrated, the fourth flexible peripheral portion 18 is shown adjoining a first side of the toe pad 32, and the fifth flexible peripheral portion 20 is shown adjoining a second side of the toe pad 32.

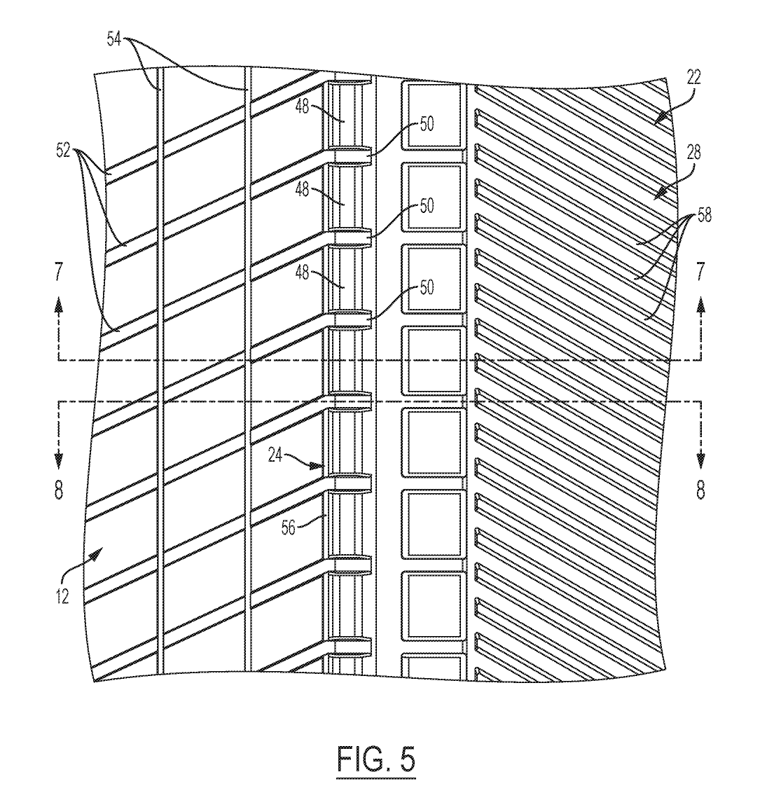

Referring to FIG. 5, the high border 24 is shown to include an upper surface 48 and a plurality of channels 50 spaced apart from one another to define a plurality of border segments.

Each of the flexible peripheral portions 12, 14, 16, 18, 20 may include a plurality of grooves. The grooves may be used as a guide for severing and removing at least one section of the flexible peripheral portions so that the vehicle floor mat 10 may be trimmed to fit the dimensions of the foot well of a particular vehicle. The grooves, and the entirety of the flexible peripheral portions themselves, may have a relatively thin wall thickness (less than a thickness dimension of the containment portion 22), so that it may be relatively easy to trim the flexible peripheral portions along the grooves with, for example, scissors or a utility knife. The grooves may also be useful in increasing the flexibility of the flexible peripheral portions and/or directing the flow of liquid into the containment portion 22.

In the example illustrated, the flexible peripheral portion 12 is shown to include lateral grooves 52 and longitudinal grooves 54. As illustrated, the lateral grooves 52 may be aligned in registration with the channels 50 for communicating liquid from the flexible peripheral portion 12 to the containment portion 22.

In the example illustrated, there is also a longitudinal groove 56 that extends adjacent to the high border 24 between the flexible peripheral portion 12 and the high border 24. The groove 56 may increase flexibility of the flexible peripheral portion 12 and thereby improve its ability to conform to the areas to the side of the floor space.

In the example illustrated, the central pan 28 includes a plurality of upwardly projecting and parallel ridges 58. As illustrated, the ridges 58 may run transversely, diagonally across the central pan 28, and define channels for collecting liquid therein. In some examples, the ridges 58 may be configured as described in U.S. Pat. Nos. 4,420,180 and 5,482,759, and sold under the brand name PANTS SAVER® (Koolatron Inc. of Brantford, Ontario, Canada). In such examples, it may be possible for the central pan 28 to hold 500 to 600 ml of liquid.

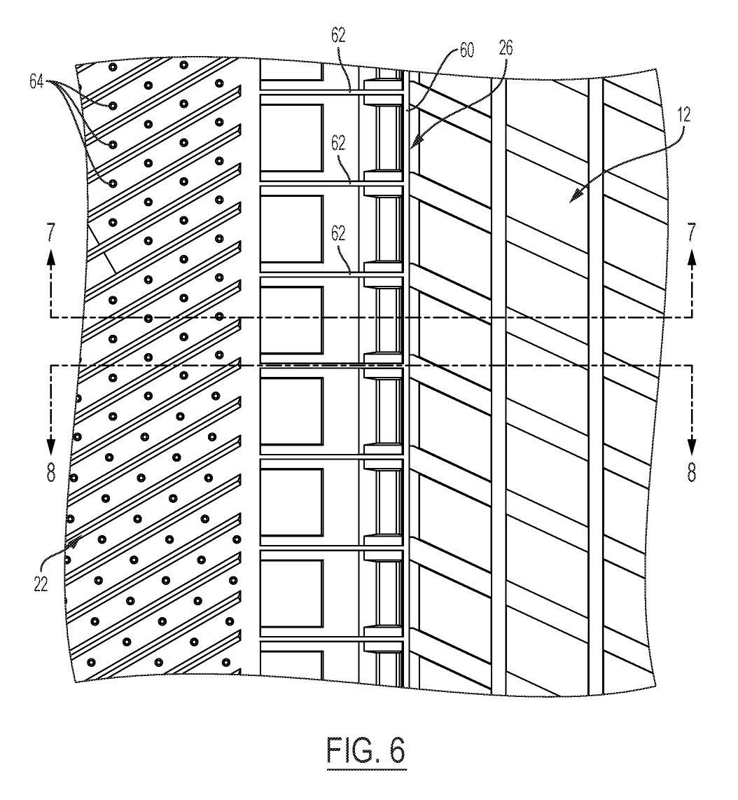

Referring to FIG. 6, the base rim 26 has a lower surface 60 for engaging a vehicle floor. In the example illustrated, ribs 62 are coplanar with the lower surface 60 and extend between the base rim 26 and the containment portion 22. Between each of the ribs 62 may be arranged a hollowed out region that may reduce the overall material requirements for the mat. On the underside surface of the containment portion 22, ground-engaging nibs 64 may be included to help secure the vehicle floor mat 10 into position.

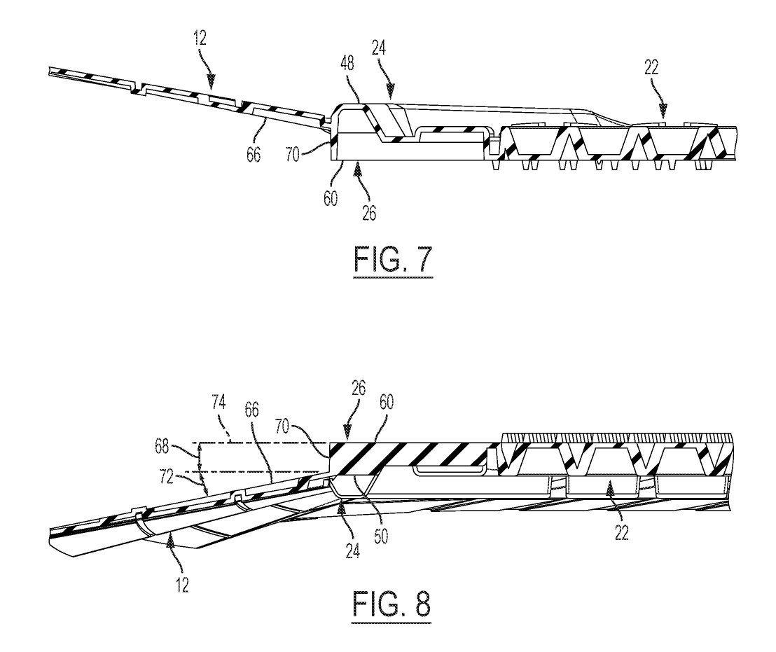

Referring to FIGS. 7 and 8, the upper surface 48 of the high border 24 is offset from the containment portion 22 in the vertical direction for segregating liquid in the containment portion 22. The flexible peripheral portion 12 has a bottom surface 66 that is offset from the lower surface 60 of the base rim 26 to define an offset dimension 68. In the example illustrated, the base rim 26 has an outer side wall 70 that extends upwardly from the lower surface 60 of the base rim 26 to the bottom surface 66 of the flexible peripheral portion 12.

In the example illustrated, the flexible peripheral portion 12 is arranged inclined upwardly at an acute angle 72 relative to a plane 74 defined by the lower surface 60 of the base rim 26. In some examples, the acute angle 72 may be between about 5 and 20 degrees.

The flexibility of the peripheral portions, the acute angle 72 and/or the offset dimension 68 may allow the vehicle floor mat 10 to effectively contour to the sides of the floor space of a given vehicle and provide good protection against moisture and the salt stains that may result during the winter season.

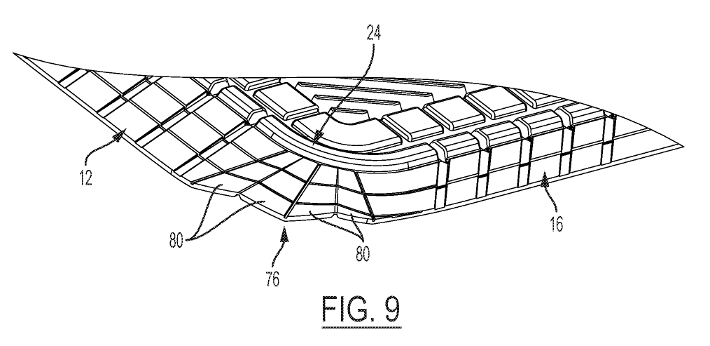

In the example illustrated, referring to FIGS. 1 and 9, the first and second peripheral portions 12, 14 and the third peripheral portion 16 interconnect at first and second corner portions 76, 78, respectively. As shown in FIG. 9, the corner portion 76 includes generally fan-shaped corrugated panels 80. The panels 80 may fold relative to one another to assist with the ability of the vehicle floor mat 10 to be contoured with the sides of the floor space of a given vehicle.

While the above description provides examples of one or more apparatuses or methods, it will be appreciated that other apparatuses or methods may be within the scope of the accompanying claims.

We claim:

1. A vehicle floor mat, comprising:
a containment portion having a top, a bottom, a length extending in a longitudinal direction and width extending in a lateral direction;
a high border generally surrounding the containment portion along the top thereof, the high border having an upper surface that is offset from the containment portion in a vertical direction for segregating liquid in the containment portion;
a base rim generally surrounding the containment portion along the bottom thereof, the base rim having a lower surface for engaging a vehicle floor; and
at least one flexible peripheral portion adjoining the containment portion, the at least one flexible peripheral portion having a bottom surface that is offset from the lower surface of the base rim in the vertical direction.

2. The vehicle floor mat of claim 1, wherein the bottom surface of the at least one flexible peripheral portion is offset from the lower surface of the base rim to define an offset dimension.

3. The vehicle floor mat of claim 2, wherein the base rim comprises an outer side wall that extends upwardly in the vertical direction from the lower surface of the base rim to the bottom surface of the at least one flexible peripheral portion.

4. The vehicle floor mat of claim 3, wherein the at least one flexible peripheral portion is arranged inclined upwardly at an acute angle relative to a plane defined by the lower surface of the base rim.

5. The vehicle floor mat of claim 4, wherein the acute angle is between about 5 and 20 degrees.

6. The vehicle floor mat of claim 1, wherein the at least one flexible peripheral portion comprises a first flexible peripheral portion adjoining a first side of the containment portion along at least a portion of the length, a second flexible peripheral portion adjoining a second side of the containment portion along at least a portion of the length, and a third flexible peripheral portion adjoining the containment portion along the width and connected between the first and second flexible peripheral portions.

7. The vehicle floor mat of claim 6, wherein each of the first and second peripheral portions has a width dimension in the lateral direction that is at least 20% of a width dimension in the lateral direction of the containment portion.

8. The vehicle floor mat of claim 6, wherein the third peripheral portion has a length dimension in the longitudinal direction that is at least 6% of a length dimension in the longitudinal direction of the containment portion.

9. The vehicle floor mat of claim 6, wherein the first and second peripheral portions and the third peripheral portion interconnect at first and second corner portions, respectively, and each of the first and second corner portions comprises a plurality of generally fan-shaped corrugated panels.

10. The vehicle floor mat of claim 1, wherein the high border comprises a plurality of channels to define a plurality of border segments.

11. The vehicle floor mat of claim 10, wherein the at least one flexible peripheral portion comprises a plurality of grooves.

12. The vehicle floor mat of claim 11, wherein the plurality of grooves comprises a plurality of lateral grooves and a plurality of longitudinal grooves.

13. The vehicle floor mat of claim 11, wherein the plurality of grooves comprises at least one groove that extends adjacent to the high border between the at least one flexible peripheral portion and the high border.

14. The vehicle floor mat of claim 11, wherein at least a portion of the plurality of grooves are aligned in registration with the channels for communicating liquid from the at least one flexible peripheral portion to the containment portion.

15. The vehicle floor mat of claim 1, wherein the high border and the base rim are arranged to generally coincide in the vertical direction.

16. The vehicle floor mat of claim 15, wherein each of the high border and the base rim comprises first and second length sections that are spaced from one another in the lateral direction and extend generally in the longitudinal direction, and a first width section that extends generally in the lateral direction between the first and second length sections.

17. The vehicle floor mat of claim 1, wherein the containment portion comprises a central pan and a heel pad adjoining the central pan, the central pan comprising a plurality of upwardly projecting ridges configured to collect liquid therebetween.

18. The vehicle floor mat of claim 17, wherein the containment portion comprises a toe pad adjoining the heel pad, the at least one flexible peripheral portion comprises a fourth flexible peripheral portion adjoining a first side of the toe pad, and a fifth flexible peripheral portion adjoining a second side of the toe pad.

19. A vehicle floor mat, comprising:
a containment portion having a top, a bottom, a length extending in a longitudinal direction and width extending in a lateral direction;
a high border generally surrounding the containment portion along the top thereof, the high border having an upper surface that is offset from the containment portion in a vertical direction for segregating liquid in the containment portion;
a base rim generally surrounding the containment portion along the bottom thereof, the base rim having a lower surface for engaging a vehicle floor, the high border and the base rim being arranged to generally coincide in the vertical direction, each of the high border and the base rim comprising first and second length sections that are spaced from one another in the lateral direction and extend generally in the longitudinal direction at least partially along the length of the containment portion, and a first width section that extends generally in the lateral direction along the width of the containment portion between the first and second length sections;
first, second and third peripheral portions, the first flexible peripheral portion adjoining the first length sections of the high border and the base rim, the second flexible peripheral portion adjoining the second length sections of the high border and the base rim, and the third flexible peripheral portion adjoining the first width sections of the high border and the base rim and connected between the first and second flexible peripheral portions, each of the first, second and third peripheral portions comprising a bottom surface that is offset from the lower surface of the base rim in the vertical direction; and
first and second corner portions that interconnect the first and second flexible peripheral portions with the third flexible peripheral portion, respectively.

20. A vehicle floor mat, comprising:
a containment portion;
a base rim generally surrounding the containment portion along a bottom thereof, the base rim comprising a lower surface for engaging a vehicle floor, and an outer side wall that extends upwardly from the lower surface; and
a flexible peripheral portion adjoining the containment portion, the flexible peripheral portion having a bottom surface that is connected to the outer side wall of the base rim, and the flexible peripheral portion is arranged inclined upwardly at an acute angle relative to a plane defined by the lower surface of the base rim.
